(19) United States
(12) Patent Application Publication
(10) Pub. No.: US 2012/0274452 A1
(43) Pub. Date: Nov. 1, 2012

(54) RADIO FREQUENCY (RF)-ENABLED LATCHES AND RELATED COMPONENTS, ASSEMBLIES, SYSTEMS, AND METHODS

(76) Inventors: Aravind Chamarti, Painted Post, NY (US); John David Downie, Painted Post, NY (US); Keith Allen Hoover, Corning, NY (US); James Scott Sutherland, Corning, NY (US); Richard Edward Wagner, Painted Post, NY (US); Dale Alan Webb, Corning, NY (US); Matthew Scott Whiting, Lawrenceville, PA (US)

(21) Appl. No.: 13/094,026

(22) Filed: Apr. 26, 2011

(51) Int. Cl. G06K 7/01

(52) U.S. Cl. 340/10.5

(57) ABSTRACT

Radio frequency (RF)-enabled latches and related components, assemblies, systems, and methods are disclosed that affect control of mating and/or demating of components. In one embodiment, a component is provided that includes a body configured to be mated to a second component to establish a connection. A latch is disposed in the body and configured to either affect demating of the body from the second component or mating of the body to the second component, when the latch is not actuated. A transponder disposed in the body can be configured to actuate the latch to either affect demating of the body from the second component or mating of the body to the second component. The transponder can also be configured to actuate the latch based on the identification information of the second transponder received through the communication connection or lack of receiving identification information from a second transponder or reader.

### BACKGROUND

1. Field of the Disclosure

The technology of the present application is related to use of radio frequency (RF) communications in communication connections, including RF identification (RFID)-equipped components.

2. Technical Background

It is well known to employ radio frequency (RF) identification (RFID) transponders to identify articles of manufacture. RFID transponders are often referred to as RFID tags. RFID tags are comprised of an antenna coupled to an integrated circuit (IC). An identification number or other characteristic is stored in the IC or in memory coupled to the IC, which can be provided to another system, such as an RFID reader, to provide identification information for a variety of purposes. For example, if the RFID tag is an active device, the RFID tag includes a transmitter that can transmit the identification to another system. If the RFID tag is a passive or semi-passive device, the RFID tag does not include a transmitter. The passive or semi-passive RFID tag includes a receiver that includes an antenna that receives a wireless RF signal from a transmitter, also known as an interrogation signal. The passive or semi-passive RFID tag wakes up in response to receipt of the interrogation signal and can respond, including providing identification information, via backscatter modulation communications.

RFID tags have been applied to communication systems to provide information regarding communication components, such as connectors and adapters as examples. In this regard, the communication components are RFID-equipped. An RFID reader can be provided as part of an RFID system to receive stored information about the RFID-equipped communication components. The RFID reader can interrogate RFID tags disposed in communication components in the range of the RFID reader to automatically discover communication components present in the RFID system. The RFID reader may provide the identification information regarding the communication components to a host computer system. The RFID tags disposed in two communication components can also exchange identification information when connected together to provide connection information to the RFID reader when interrogated. Thus, it is possible to determine when two particular communication components are connected or joined together and when the connection is separated.

Network equipment may be provided that is configured to support interconnections of a number of RFID-equipped communication components. A technician provides the desired interconnections to establish communications. If a technician accidentally disconnects an incorrect communication component that is RFID-equipped the host computer system can flag an error or provide another indicator to inform the technician, but not before a communication connection is broken. The unintended disconnection may result in interruption in communication services and loss of data. Also, connecting the incorrect communication components together can also cause similar issues. An unintended connection between communication components could result in information being exchanged improperly from one party to another when such exchange is not proper or authorized.

The same results can occur for other applications in addition to communications. For example, if an RFID-equipped power connector is incorrectly disconnected, a host computer system may be able to detect the disconnection, but not before power is interrupted. If the power connector is allowing power to be supplied to a critical device, such as a medical device for example, the interruption of power could be life threatening.

### SUMMARY OF THE DETAILED DESCRIPTION

Embodiments disclosed in the detailed description include radio frequency (RF)-enabled latches and related components, assemblies, systems, and methods that affect control of mating and/or demating of the components with other components for any purpose or application desired. To affect means to either allow or prevent mating and/or demating of the components with other components. Mating means that a connection is established. Demating means that a connection is broken or disestablished. The components may be connection components as an example. In this regard, wireless RF communications can be employed to communicate to a transponder disposed in a component to control a latch. The latch controls whether the component can be mated with a second component and/or demated from the second component. Thus, these embodiments allow, for example, the ability to affect and/or maintain connections between components to avoid technician mistakes when making or configuring connections. For example, the latch may be controlled based on identification information received from the second component. If the connection is proper based on the identification information, the latch can be controlled through the transponder to affect mating and/or demating of the component to and/or from the second component based on this identification information.

In this regard, in one embodiment, a component is provided that includes a body configured to be mated to a second component to establish a connection. A latch is disposed in the body and configured to either affect demating of the body from the second component or mating of the body to the second component, when the latch is not actuated. A transponder is also disposed in the body. The transponder is configured to establish a communication connection to a second transponder disposed in the second component when the body is mated to the second component. The transponder can be configured to actuate the latch to either affect demating of the body from the second component or mating of the body to the second component. The transponder can also be configured to actuate the latch based on the identification information of the second transponder received through the communication connection or lack of receiving identification information from a second transponder or reader. The transponder may, for example, be a radio frequency (RF) identification (RFID) device.

In another embodiment, a method for affecting mating and/or demating of a component is provided. The method includes mating a body to a second component to establish a connection. The method also includes receiving an instruction at a transponder disposed in the body to actuate a latch disposed in the body to either affect demating of the body from the second component or affect mating of the body to the second component based on identification information of the transponder. The method can also include actuating the latch based on the identification information of the second transponder received through the communication connection or lack of receiving identification information from a second transponder or reader.

In another embodiment, a component system is provided. The system includes a first component that comprises a first body and a first transponder disposed in the first body. The system also includes a second component that comprises a second body configured to be mated to the first body to establish a connection with the first component and a second latch disposed in the second body and configured to either affect demating of the first body from the second body or mating of the first body to the second body, when the second latch is not actuated. A second transponder is disposed in the second body and configured to establish a communication connection to the first transponder when the first body is mated to the second body. The second transponder is configured to receive an instruction to actuate the second latch to either affect demating of the second body from the second component or mating of the second body to the second component. The transponders can also be configured to actuate the latches based on the identification information of the other transponder received through the communication connection or lack of receiving identification information from a transponder or reader.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the invention as it is claimed. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic view of an exemplary component employing a radio frequency (RF)-enabled latch according to exemplary embodiments disclosed herein;

FIG. 2 is a side view of a cross-section of an exemplary connector component having an exemplary RF-enabled latch prior to mating with an exemplary adapter component having an exemplary RF-enabled latch, wherein the RF-enabled latches are biased such that only one of the RF-enabled latches is required to be actuated to allow the connector component to be demated from the adapter component;

FIG. 3 illustrates the connector component of FIG. 2 mated to the adapter component of FIG. 2 with the RF-enabled latch of the connector component unactuated to lock the connector component to the adapter component;

FIG. 4 illustrates the RF-enabled latch of the connector component of FIG. 2 actuated and mated to the adapter component of FIG. 2;

FIG. 5 illustrates the RF-enabled latch of the adapter component of FIG. 2 actuated to allow the connector of FIG. 2 to be demated from the adapter component;

FIG. 6 is a side view of a cross-section of an exemplary connector component having an exemplary latch prior to mating with an exemplary adapter component having an exemplary RF-enabled latch, wherein the RF-enabled latch is biased such that the RF-enabled latch is required to be actuated to prevent demating of the connector component from the adapter component;

FIG. 7 illustrates the RF-enabled latch of the adapter component of FIG. 6 not actuated to allow the connector of FIG. 6 to be demated from the adapter component;

FIG. 8 illustrates the connector component of FIG. 6 mated to the adapter component of FIG. 6 with the RF-enabled latch of the adapter component actuated to prevent demating of the connector component from the adapter component;

FIG. 9 is a schematic diagram of an exemplary connection mapping system utilizing connector component RF-enabled latches disposed in connector components and adapter components;

FIG. 10 is a schematic diagram of exemplary connections between integrated circuits disposed in a connector component connected to an adapter component, each including RF-enabled latches;

FIG. 11 is a side view of a cross-section of an alternative exemplary connector component having an exemplary RF-enabled latch after mating with an alternative exemplary adapter component having an exemplary RF-enabled latch, wherein the RF-enabled latches are biased such that both RF-enabled latches must be actuated to allow the connector component to be demated from the adapter component;

FIG. 12 illustrates the RF-enabled latch disposed in the adapter component of FIG. 11 actuated and the RF-enabled latch disposed in the connector component of FIG. 11 unactuated, wherein the connector component is prevented from being demated from the adapter component;

FIG. 13 illustrates both RF-enabled latches disposed in the connector component and adapter component of FIG. 11 actuated to allow the connector component to be demated from the adapter component;

FIG. 14 illustrates the connector component of FIG. 11 demated from the adapter component of FIG. 11;

FIG. 15 is a side view of a cross-section of the RF-enabled connector component and adapter component of FIGS. 2-5, wherein a coil spring is further included in the adapter component to automatically demate the connector component from the adapter component when one of the RF-enabled latches is actuated;

FIG. 16 is a side view of a cross-section of the RF-enabled connector component and adapter component of FIGS. 2-5, wherein a deformable spring is further included in the adapter component to automatically demate the connector component from the adapter component when one of the RF-enabled latches is actuated;

FIG. 17 is a side view of a cross-section of an alternative exemplary connector component having an exemplary RF-enabled latch after mating with an alternative exemplary adapter component having an exemplary RF-enabled latch, wherein the RF-enabled latches are biased such that the connector component can be demated from the adapter component without actuating either of the RF-enabled latches;

FIG. 18 is a side view of a cross-section of the connector component and adapter component of FIGS. 2-5, wherein the RF-enabled latch disposed in the connector component is not manually actuated and a separate manually-actuated latch is provided;

FIG. 19 is a side view of a cross-section of exemplary connector components having exemplary RF-enabled latches configured to be mated with an adapter component having an exemplary RF-enabled latch, wherein the RF-enabled latches are biased such that only one of the RF-enabled latches between the connector component RF-enabled latch and the adapter component RF-enabled latch is required to be actuated to allow a connector component to be demated from the adapter component, and such that neither of the RF-enabled latches must be actuated to allow the connector component to be mated to the adapter component;

FIG. 20 illustrates the connector components and adapter component of FIG. 19, with both connector components mated to the adapter component; and

FIG. 21 illustrates a top perspective view of an exemplary fiber optic connection arrangement of two exemplary duplex LC fiber optic connectors each having RF-enabled latches connected to an exemplary intermediary duplex LC fiber optic adapter having an RF-enabled latch.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like parts.

Embodiments disclosed in the detailed description include radio frequency (RF)-enabled latches and related components, assemblies, systems, and methods that affect control of mating and/or demating of the components with other components for any purpose or application desired. In one example, the RF-enabled latches are RF identification (RFID)-enabled latches, wherein RFID transponders are provided and configured to control the mating and/or demating of components with other components. The present disclosure is not limited to RFID, and any component or device capable of receiving RF signals may be employed to provide a RF-enabled latch. To affect means to either allow or prevent mating and/or demating of the components with other components. Mating means that a connection is established. Demating means that a connection is broken or disestablished. The components may be connection components as an example. In this regard, wireless RF communications can be employed to communicate to a transponder disposed in a component to control a latch. The latch controls whether the component can be mated with a second component and/or demated from the second component. Thus, these embodiments allow, for example, the ability to prevent and/or maintain connections between components to avoid technician mistakes when making or configuring connections. For example, the latch may be controlled based on identification information received from the second component. If the connection is proper based on the identification information, the latch can be controlled to affect mating and/or demating of the component to and/or from the second component based on this identification information.

In this regard, in one embodiment, a component is provided that includes a body configured to be mated to a second component to establish a connection. A latch is disposed in the body and configured to either affect demating of the body from the second component or mating of the body to the second component, when the latch is not actuated. A transponder is also disposed in the body. The transponder is configured to establish a communication connection to a second transponder disposed in the second component when the body is mated to the second component. The transponder can be configured to actuate the latch to either affect demating of the body from the second component or mating of the body to the second component. The transponder can also be configured to actuate the latch based on the identification information of the second transponder received through the communication connection or lack of receiving identification information from a second transponder or reader. The transponder may, for example, be an RFID device.

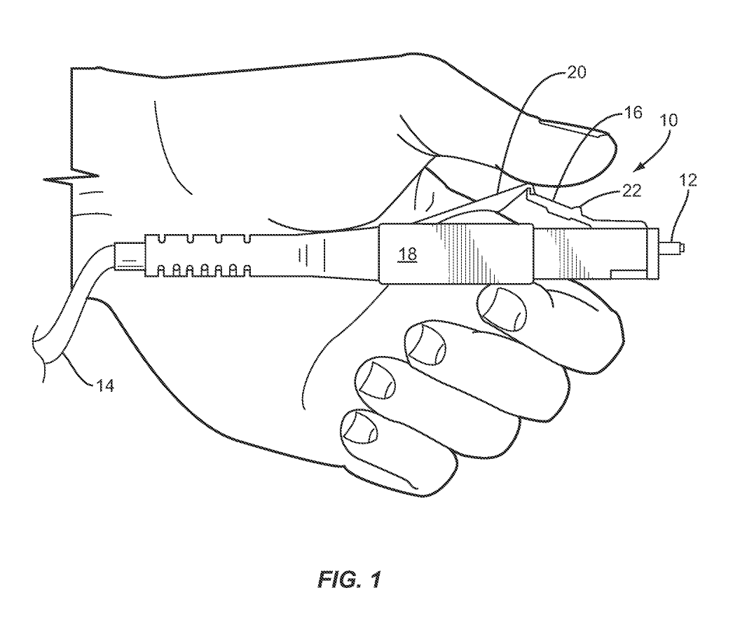

As a non-limiting example, FIG. 1 illustrates a schematic view of a duplex LC fiber optic connector 10 as a connector component. The duplex LC fiber optic connector 10 provides one or more optical ferrules 12 carrying one or more optical fibers from a fiber optic cable 14. The duplex LC fiber optic connector 10 includes a manually-actuated latch 16 disposed in the a body 18 of the duplex LC fiber optic connector 10 that can be actuated by a technician by pressing down on a latch engager 20, which in turn applies a force on the manually-actuated latch 16. When the manually-actuated latch 16 is lowered, a protrusion 22 disposed in the manually-actuated latch 16 is lowered and allowed to clear a complementary protrusion in an adapter component (not shown) to affect a latching mechanism to allow the body 18 the duplex LC fiber optic connector 10 to be inserted and mated with the adapter connector (not shown) to establish a connection.

Release of the manually-actuated latch 16 will cause the protrusion 22 to raise and prevent demating of the body 18 of the duplex LC fiber optic connector 10 from the adapter connector. If it is desired to disengage or demate the duplex LC fiber optic connector 10 from an established connection to an adapter connector, the technician actuates the manually-actuated latch 16 in the same manner to clear the protrusion 22 from a complementary protrusion in the adapter connector to affect the manually-actuated latch 16 to allow the body 18 to be demated from the adapter component.

Thus, in the connector example of FIG. 1, the technician is in control of whether the duplex LC fiber optic connector 10 can be mated with an adapter component based on control of engagement of the manually-actuated latch 16. If the technician connects the duplex LC fiber optic connector 10 to the incorrect adapter component, an incorrect connection may be established. For example, if the connection is a communication connection, communications may be established through the duplex LC fiber optic connector 10 that are not desired. Such could, for example, direct communications intended for one device or party to another incorrectly and comprise privacy issues as well. Further, if a technician engages the manually-actuated latch 16 to demate the body 18 of the duplex LC fiber optic connector 10 from the adapter component, the connection is broken. If the technician incorrectly disconnects the duplex LC fiber optic connector 10, a connection may be broken that is not desired or intended to be broken. Such may disrupt a desired connection unintentionally. For example, if the connection is a communication connection, communications will be cut off through the duplex LC fiber optic connector 10.

Thus, embodiments disclosed herein include radio frequency (RF)-enabled latches and related connectors, assemblies, systems, and methods that allow control of mating and/or demating of the components with other components, which may include connector components. The RF-enabled latches allow RF communications to control in whole or part whether a component can be mated or demated to provide a degree of control beyond a technician manually employing a manually-actuated latch for example. These embodiments can assist, for example, in security measures by ensuring that only authorized users can add or remove connections by mating and demating of components. Further, these embodiments can provide ease of use as another example in that a technician can be provided with an indication that a particular component selected for mating or demating is the correct component. Further, as another example, network interconnection database integrity can be maintained when the components are used for communication connections. Controlling mating and/or demating other than through purely a technician-actuated latch can allow confidence that a database of established connections is the current physical interconnection state of a network.

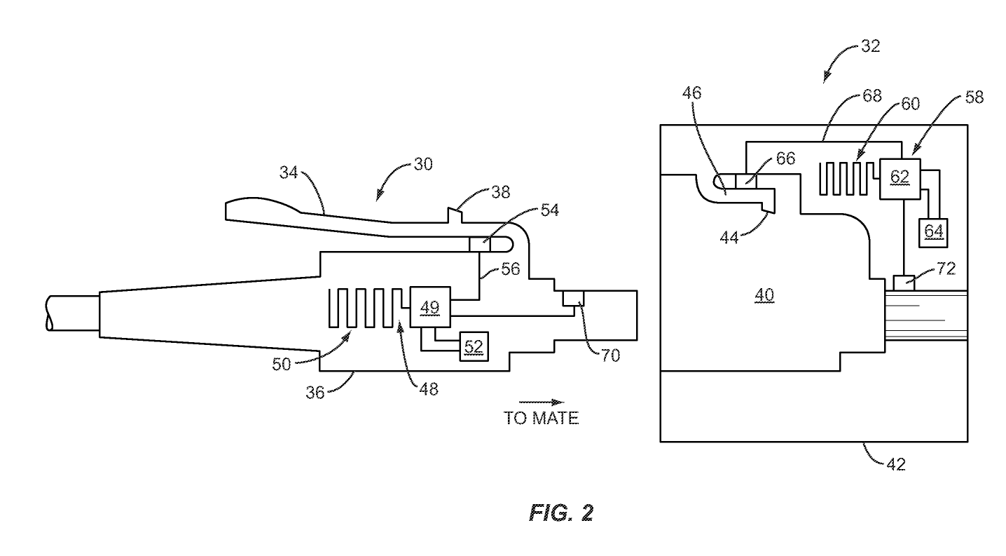

In this regard, FIG. 2 illustrates a cross-section of a first exemplary embodiment of a first component provided in the form of a first connector 30 and a second component providing in the form of a second connector 32 employing RF-enabled latches that can be controlled to affect a latch 34 to allow the mating and/or demating of the first connector 30 to and/or from the second connector 32, as discussed below in more detail. The first connector 30 is illustrated in FIG. 2 as being disconnected or demated from the second connector 32. In this example, the second connector 32 is an adapter component that is configured to receive the first connector 30 to establish a connection. The first and second connectors 30, 32 can be any type of connectors, including but not limited to electrical connectors, fiber optic connectors, communication connectors, a plug, a socket, adapters of any of the aforementioned, or any other connector of a mating pair or set. The mating of the first and second connectors 30, 32 may establish a connection, including but not limited to a communication connection. The connection may only be established when the first connector 30 is either partially or fully inserted into the second connector 32 to form a mating between the first connector 30 and the second connector 32.

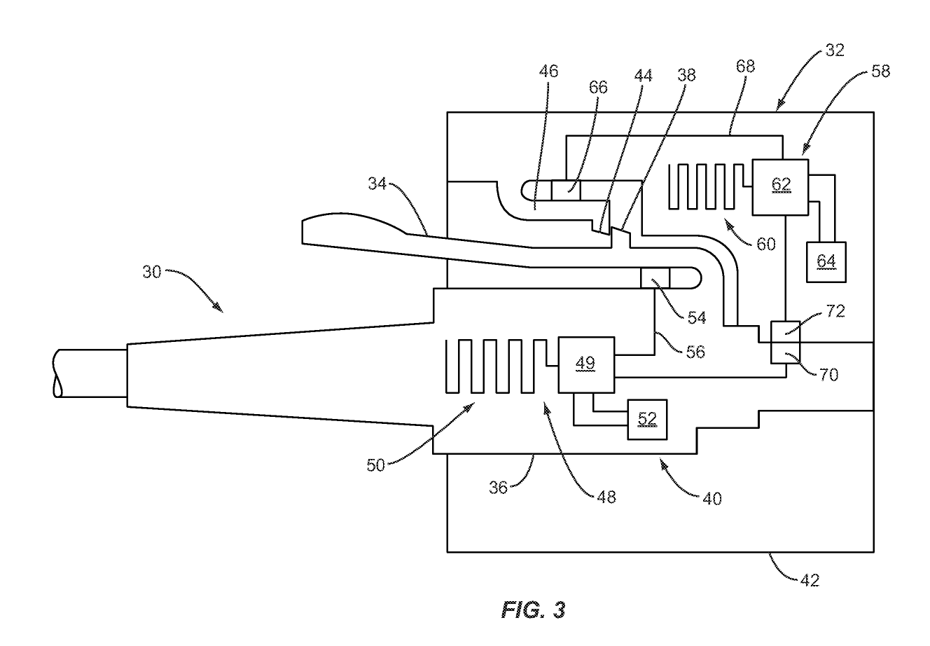

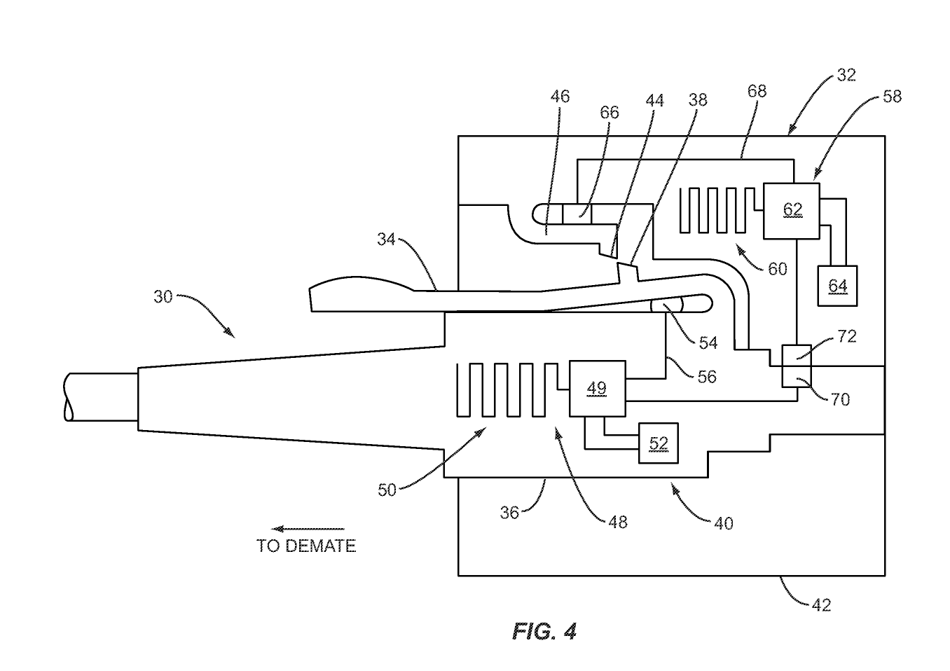

To control mating and demating of the first connector 30 to and from the second connector 32, the first connector 30 in the embodiment of FIG. 2 includes a latch 34. The latch 34 is disposed in a body 36 and includes a protrusion 38 disposed in the latch 34 to control whether the first connector 30 can be mated to or demated from the second connector 32. The second connector 32 in this example includes an internal chamber 40 disposed in a body 42 of the second connector 32 that includes a geometry configured to receive a complementary, fitted geometry of the body 36 of the first connector 30. When the first connector 30 is mated with the second connector 32, as illustrated in FIG. 3, the protrusion 38 is prevented from clearing a complementary protrusion 44 disposed in a latch 46 disposed in the body 42 of the second connector 32. Actuating the latch 34 affects the latch 34 to allow demating of the first connector 30 from the second connector 32. To clear the protrusion 38 from the protrusion 44 to affect the latch 34 to allow demating, a manual force can be applied by a technician downward on the latch 34, which will in turn lower the protrusion 38 allowing it to clear the protrusion 44 during demating, as illustrated in FIG. 4. The body 36 of the first connector 30 will then be free to be pulled out of the internal chamber 40 of the second connector 32 to demate the two from each other, as illustrated in FIG. 2.

The protrusions 38, 44 in this embodiment are also biased such that when the first connector 30 is inserted into the internal chamber 40 of the second connector 32, as illustrated in FIG. 4, the protrusions 38, 44 interfere with each other without a technician being required to engage the latch 34. The protrusions 38, 44 are biased such that they interfere with each other as the first connector 30 is inserted into the internal chamber 40 of the second connector 32 and automatically applies a force to their respective latches 34, 46 to affect the latches 34, 46 to allow the protrusions 38, 44 to clear each. The protrusions 38, 44 are biased according to the direction of the angle disposed therein. This allows the mating of the first connector 30 with the second connector 32 without manual engagement of the latch 34 by a technician, if desired.

To this point, the demating of the first connector 30 from the second connector 32 has been described with regard to actuation of the latch 34 by a technician to clear the protrusion 38 from the protrusion 44 of the latch 46 disposed in the second connector 32. It may be desired to provide radio frequency (RF) control of the latch 34 as well to affect the latch 34 to allow the demating of the first connector 30 from the second connector 32. In this regard, a transponder 48 is disposed in the body 36 of the first connector 30. The transponder 48 in this embodiment is an RF identification (ID) (RFID) transponder that is configured to store and return an identification when interrogated by a reader. If identification of the transponder 48 is necessary or desired as described herein, the transponder 48 can be provided as an RFID transponder.

The transponder 48 in this embodiment is a passive transponder that includes an integrated circuit (IC) chip 49 containing integrated circuits that is powered from RF energy harvested or received from a reader through an antenna 50 coupled to the IC chip 49. The IC chip 49 enables certain functionality and communication for the transponder 48. In this regard, a capacitor 52 may be communicatively coupled to the IC chip 49 to store excess energy received through the antenna 50 for providing power to the IC chip 49 when the antenna 50 is not receiving an RF signal from a reader, such as an RFID reader, and/or to supplement such power during times when power demand may be greater than harvested through the antenna 50. Note that the transponder 48 could also be a semi-passive or active device. A semi-passive transponder may include a power source to assist in powering the transponder. An active transponder includes a power source and a transmitter.

The transponder 48 in this embodiment is configured to actuate a latching mechanism 54 to actuate the latch 34 in the first connector 30, as illustrated in FIG. 4. In this manner, in addition to manual activation of the latch 34 by a technician, the latch 34 can also be actuated by the transponder 48 in response to a received instruction. In this regard, the latch 34 is also RF-enabled. In this embodiment, the transponder 48 can provide a signal over a communication line 56 to control whether the latching mechanism 54 maintains the latch 34 in an unactuated position, as illustrated in FIGS. 2 and 3, or if the latching mechanism 54 allows the latch 34 to be actuated, as illustrated in FIG. 4. As previously discussed and illustrated in FIGS. 2-4, when the latch 34 is actuated, the protrusion 38 is allowed to clear the protrusion 44 regardless of the actuation state of the latch 46, to affect the latch 34 to allow the first connector 30 to be demated from the second connector 32. The transponder 48 can be configured to actuate the latching mechanism 54 to actuate the latch 34 in response to receipt of an instruction from an RF signal received by the antenna 50. Thus, the latch 34 in this embodiment, by being RF-enabled, can be controlled in a manner other than by manual activation of the latch 34 by a technician to affect the latch 34 to allow the demating of the first connector 30 from the second connector 32. As examples, the latching mechanism 54 may be comprised of a bladder, a motor, a solenoid, a thermal actuator, a microelectromechanical systems (MEMs) device, or a motion-inducing device, as examples.

In another embodiment, the latching mechanism 54 does not have the ability to mechanically move the latch 34 from an actuated to released state. Instead, the latching mechanism 54 enables the latch 34 to be moved via external actuation (e.g., by a technician or stored energy, such as in a spring). In this mode, the latching mechanism 54 can serve as a brake that restricts motion of the latch 34 unless the latching mechanism 54 is activated. For example, the latching mechanism 54 could be formed from a fluid that changes viscosity with applied electric field (e.g., an electrorheological fluid) or a magnetic field (e.g., a magnetorheological fluid). In a high viscosity state, the fluid could inhibit motion of the latch 34 even when the force is applied to the latch 34 to unlatch it by a technician.

Alternatively, the latch 34 could be designed to simply vary the amount of force required for the first connector 30 to be demated from the second connector 32. When the latching mechanism 54 is in an actuated state to release the latch 34, the first connector 30 may easily be demated from the second connector 32. When the latching mechanism 54 is not actuated to provide the latch 34 in an engaged state, the first connector 30 may only be demated from the second connector 32 when a significant pulling force is applied to the first connector 30. This force could serve as an indication to a technician that the demating of the first connector 30 from the second connector 32 is not enabled, but this would still allow the technician to demate the first connector 30 from the second connector 32 if necessary, in an override condition.

Further, the latching mechanism 54 may require significant power for actuation, even if for a short period of time. If the power harvested by the antenna 50 of the transponder 48 is low, the capacitor 52 may be employed to store excess power to be used to actuate the latching mechanism 54, when desired. This capacitor 52 may also be used to provide stored power for other applications employed by the transponder 48 as well. Alternatively, a separate power source could be provided to provide power for the latching mechanism 54. The power source may be electrically coupled to the latching mechanism 54 through an interface connection with the second connector 32, as will be described in more detail below. An electromagnet could be employed in the second connector 32 to control actuation of the latching mechanism 54.

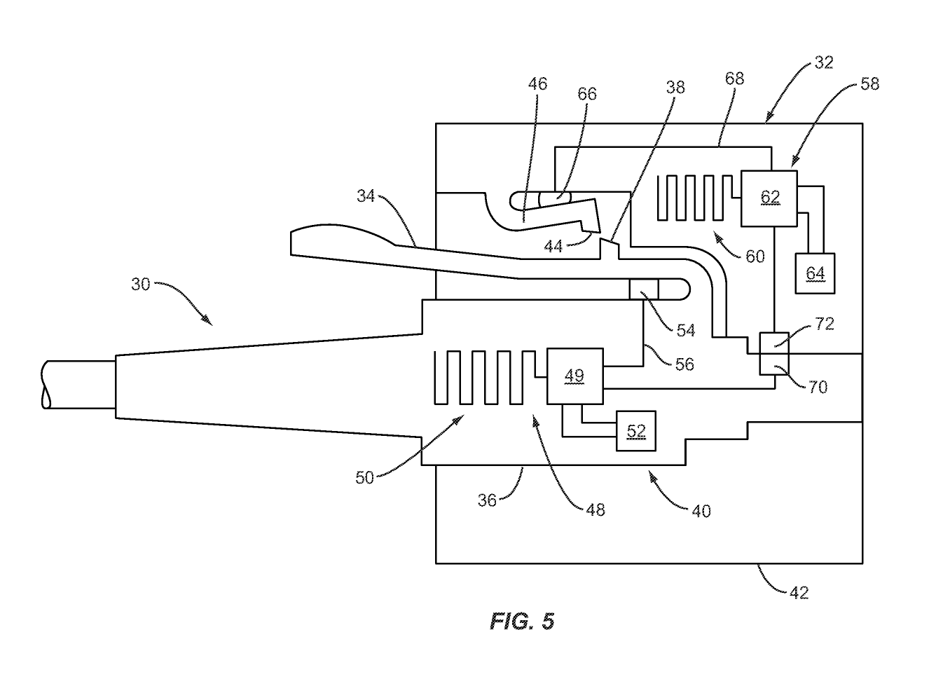

In this embodiment, the second connector 32 also includes a transponder 58, also referred to as “second transponder 58.” The second transponder 58 may be an RFID transponder. The second transponder 58 disposed in the second connector 32 in this embodiment also includes an antenna 60 coupled to an IC chip 62 to receive RF signals and a capacitor 64 coupled to the IC chip 62 to store and/or supplement power for operation of the IC chip 62. The second transponder 58 in this embodiment is also configured to actuate a latching mechanism 66 to actuate the latch 46 in the second connector 32, as illustrated in FIG. 4. In this manner, the latch 46 can be actuated by the second transponder 58. In this regard, the latch 46 is also RF-enabled. The second transponder 58 can provide a signal over a communication line 68 to control whether the latching mechanism 66 maintains the latch 46 in an unactuated position, as illustrated in FIGS. 2 and 3, or if the latching mechanism 66 actuates the latch 46, as illustrated in FIG. 5.

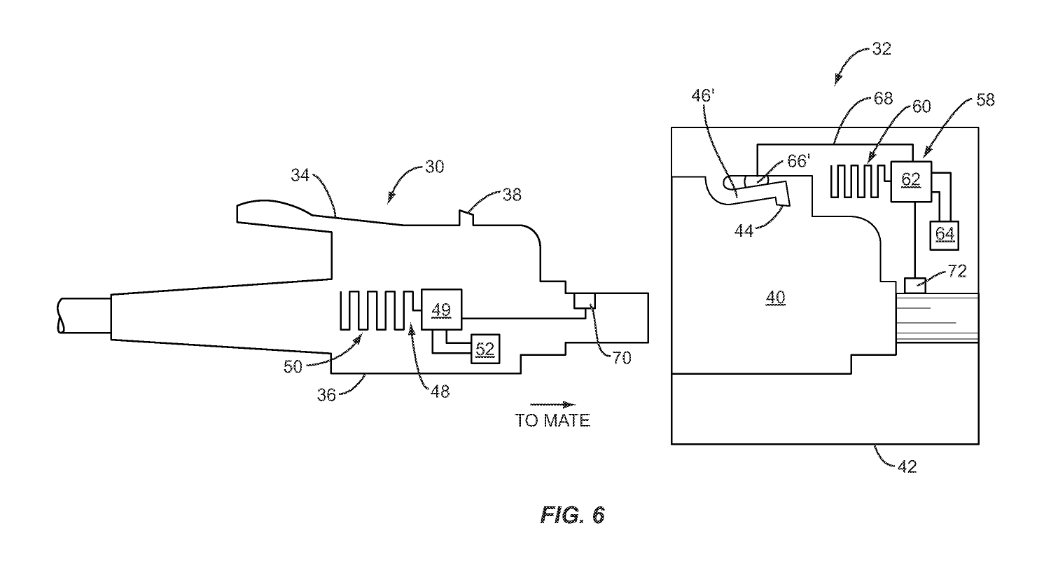

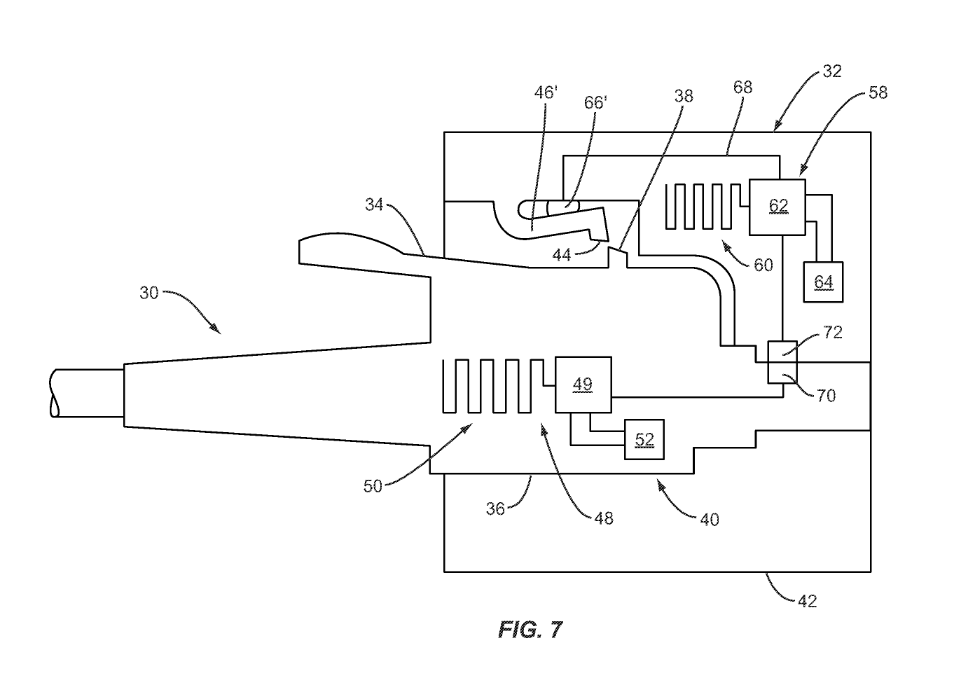

FIGS. 2-5 discussed above provide that the first connector 30 is allowed to be demated from the second connector 32 when either latches 34 or 46 are actuated. The first connector 30 and second connector 32 can also be configured to affect the latching mechanism 54 to prevent the first connector 30 from being demated from the second connector 32 if desired. In this regard, FIG. 6 is a side view of a cross-section of the first connector 30 and second connector 32 provided in FIGS. 2-5. However, a latch 46′ is provided that is disposed in a normally upward position when a latching mechanism 66′ is not actuated, as opposed to a normally downward position when the latching mechanism 66 is not actuated as provided in the latch 46 in FIGS. 2-5. In this manner, the protrusion 44 in the latch 46′ in FIG. 6 does not interfere with the protrusion 38 in the latch 34 when the latch 46′ is not actuated. As illustrated in FIG. 7, the first connector 30 is free to be inserted into and mated with the second connector 32, and is free to be demated from the second connector 32 after it has been mated.

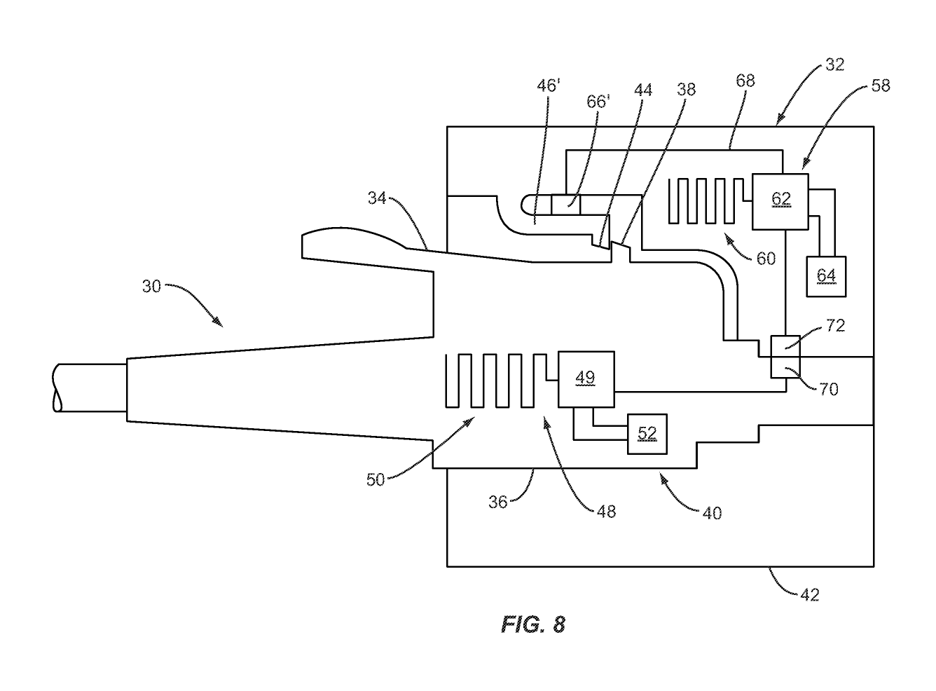

However, as illustrated in FIG. 8, after the first connector 30 is mated with the second connector 32 and the latching mechanism 66′ is actuated, the latching mechanism 66′ causes the latch 46′ to move downward such that the protrusion 44 in the latch 46′ is moved downward to prevent the protrusion 38 in the latch 34 from passing. Thus, the first connector 30 is prevented from being demated from the second connector 32. To allow the first connector 30 to be demated from the second connector 32, the latching mechanism 66′ can be unactuated so that the protrusion 44 moves upward back to its normal position and thus will not interfere with the protrusion 38 in the latch 34 when the first connector 30 is demated from the second connector 32, as illustrated in FIGS. 6 and 7. Other common elements between the first connector 30 and the second connector 32 between FIG. 6-8 and FIGS. 2-5 are shown with common element numbers and are not re-described.

As previously discussed and illustrated in FIGS. 2-5 and 6-8, when the latch 46 is actuated or the latch 46′ is deactuated, the protrusion 44 is allowed to clear the protrusion 38 regardless of the actuation state of the first latch 34, to affect the latch 46, 46′ to allow the second connector 32 to be demated from the first connector 30. The second transponder 58 can be configured to actuate the latching mechanism 66 to actuate the latch 46 (FIGS. 2-5) or actuate the latching mechanism 66′ to actuate the latch 46′ (FIGS. 6-8) in response to receipt of an instruction from an RF signal received by the antenna 60. Thus, the latches 46, 46′ in these embodiments, by being RF-enabled, can be controlled by an RF signal, such as from a reader, to affect the latches 46, 46′ to allow or prevent the demating of the second connector 32 from the first connector 30. As examples, the latching mechanisms 66, 66′ may include, but are not limited to, any of the possibilities recited above for the latching mechanism 54. Actuation of the latching mechanisms 66, 66′ may be accomplished, for example, by any of the actuation methods discussed above and for the latching mechanism 54.

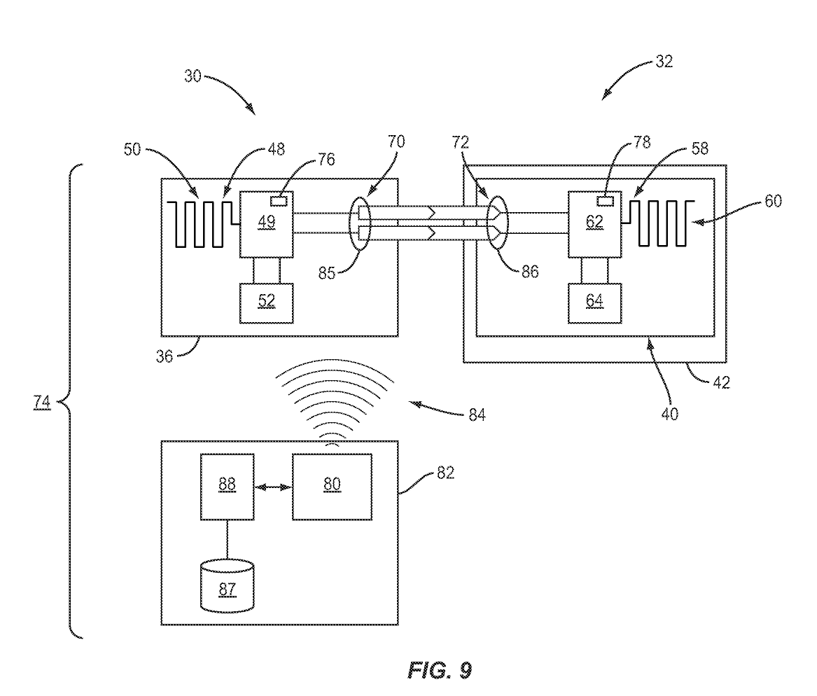

FIG. 9 illustrates an exemplary embodiment of a component mating system 74 where the transponder 48 of the first connector 30 is in electrical communication with the transponder 58 of the second connector 32 to further describe possible information exchanges between the two, including identification information. In this regard and example, the transponders 48, 58 can be provided as RFID transponders to provide this identification information. The transponders 48 and/or 58 can be configured to actuate their respective latches 34, 46 to affect the latches 34, 46 to allow the demating of the first connector 30 to and/or from the second connector 32 in FIGS. 2-5. Actuation may be based on the identification information provided by the first connector 30 to the second connector 32, or vice versa, or based on identification information exchanges between both the first and second connector 30, 32, although not required. Actuation may also be based on lack of receiving identification information provided by the first connector 30 to the second connector 32, or vice versa. The transponders 48, 58 may perform processing to determine if their respective latches 34, 46 should be actuated, or such processing may be performed by a reader, an RFID reader, or other system. The reader or other system may be able to wirelessly communicate with one or more of the transponders 48, 58 to receive the identification information as an example. Such processing may include actuation of one or both of the latches 34, 46 to affect the latches 34, 46 to allow demating of the first connector 30 from the second connector 32. Actuation of one or both of the latches 34, 46 may be based on whether the identification information is deemed proper according to defined criteria or connection configurations desired.

In this regard, as illustrated in the example in FIG. 9, the first connector 30 is mated to the second connector 32. The IC chips 49, 62 of the first and second connectors 30, 32 each include memory 76, 78 that have stored identification information regarding the IC chips 49, 62. Thus, this identification information can be used to identify the IC chip 49 distinctly from the second IC chip 62, and thus the first connector 30 distinctly from the second connector 32. The identification information can be communicated to a reader in the form of an RFID reader 80 provided as part of an RFID reader system 82 in this example.

As previously discussed in this embodiment, the transponders 48, 58 are passive devices. Passive RFID devices do not require their own power sources. Power can be harvested from an interrogation signal 84 transmitted by the RFID reader 80 in the RFID reader system 82 and received by the antennas 50, 60. Thus, passive RFID devices may be desired when providing a power supply is not desired or otherwise impractical due to cost or size limitations. The antennas 50, 60 may be any type of antenna that is tuned to the desired reception and/or transmission frequency(s), including but not limited to a dipole and monopole antenna. The antennas 50, 60 can be external to or integrated in the IC chips 49, 62.

Also in this embodiment, both the first connector 30 and the second connector 32 provide interfaces 70, 72 (also shown in FIGS. 2-5), respectively, that contain one or more electrical leads 85, 86 each coupled to their respective IC chips 49, 62. The electrical leads 85, 86 are designed to come into direct contact with each other when the first connector 30 is mated to the second connector 32 in this embodiment to form a wired connection, as illustrated in FIGS. 3, 4, and 9. When the electrical leads 85, 86 come into direct electrical contact in this embodiment with each other as a result of the connection, a connection event occurs. In response, the IC chips 49, 62 of the first and second connectors 30, 32, respectively, initiate communications with each other over the electrical leads 85, 86. Contact other than direct contact between the electrical leads 85, 86 is also possible, including capacitive and inductive coupling. Identification information regarding the identity of the first connector 30 and the second connector 32 stored in memory 76, 78, respectively, can be exchanged and stored to signify the connection of the first connector 30 to the second connector 32. Similarly, lack of exchange of identification information can be used to signify the lack of connection between the first connector 30 and the second connector 32. Thus, for example, if the IC chip 49 in the first connector 30 receives and stores an identification of the IC chip 62 in the second connector 32, it can be determined by the RFID reader 80 (FIG. 9) interrogating the IC chip 49 in the first connector 30 that the first connector 30 is mated with the second connector 32. The same is possible in vice versa—the RFID reader 80 can interrogate the second connector 32 and identification information stored in the IC chip 62 regarding the identification information of the IC chip 49 can be used to determine if the second connector 32 is mated with the first connector 30. Lack of identification information exchanged between the first connector 30 can be used to indicate to the first connector 30 and/or the RFID reader 80 that the first connector 30 is not mated with the second connector 32.

Either one or both of the first connector 30 and the second connector 32 can also communicate their own identification information as well as exchange identification information with the other connector 32, 30, respectively, as well as the RFID reader 80. The first and second connectors 30, 32 may communicate other information stored in memory, such as serial number, type of connector, cable type, manufacturer, manufacturing date, installation date, location, lot number, performance parameters (such as attenuation measured during installation), identification of what is at other end of the cable, etc. Such information could be preloaded on the memory 76, 78 of the transponders 48, 58 at manufacture or upon installation via the RFID reader 80.

The RFID reader system 82 coupled to the RFID reader 80 may be configured to receive identification information pairs signifying the first connector 30 mated to the second connector 32 within the range of the RFID reader 80. This information may be stored in a database 87 provided in the RFID reader system 82 processed in a component management system 88, as illustrated in FIG. 6. The component management system 88 may include control systems and related software for processing the information received from the first and second connectors 30, 32 to perform a number of tasks. These tasks include, but are not limited to, recording the identification information pairs, providing identification information pairs information to a technician, recording which connectors are not mated, and providing other troubleshooting and diagnostic information, as will be described in greater detail below. The processing may include decision-making on whether to communicate to one or both of the transponders 48, 58 to provide instructions to cause the transponders 48, 58 to actuate their latches 34, 46 to affect the latches 34, 46 to allow demating based on the identification information. Furthermore, the component management system 88, and any associated database 87 and/or processing element, includes stored information relating to one or more transponders in order to facilitate identification, mapping, or other processing of the information received from one or more transponders. More specifically, the RFID reader 80 includes information that correlates a unique identification number of a transponder 48, 58 to the first and second connectors 30, 32, respectively, and to any other parameter, connection, association, or other information that a technician may want to know or record when working with and/or monitoring the first and second connectors 30, 32.

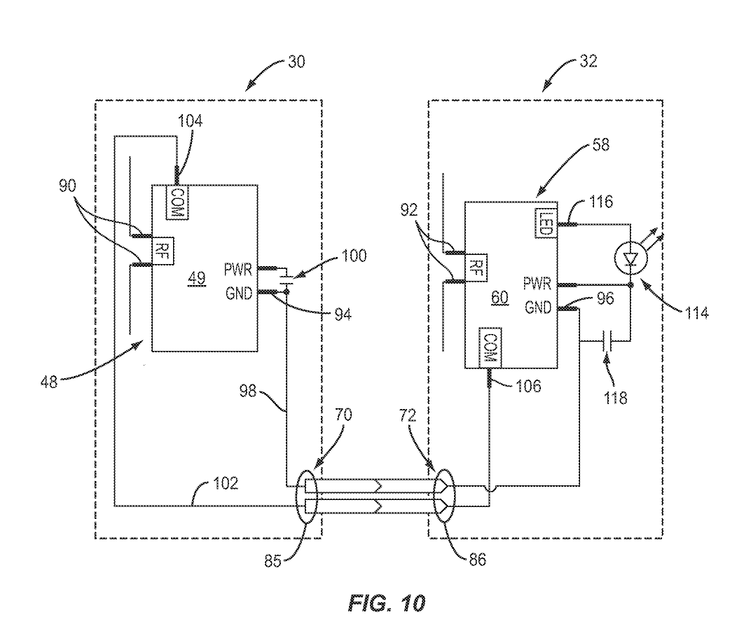

To provide further detail regarding how the IC chips 49, 62 in the transponders 48, 58 may be communicatively coupled together by example, FIG. 10 is provided. FIG. 10 illustrates more detail on an exemplary chip and pin layout of exemplary IC chips 49, 62 of the transponders 48, 58 of the component mating system 74 in FIG. 9. The IC chips 49, 62 are electrically and communicatively coupled to each other when their respective first connector 30 and second connector 32 are mated. The IC chips 49, 62 of the transponders 48, 58 are coupled together when connections are made between the first and second connectors 30, 32.

Each IC chip 49, 62 in this embodiment contains RF inputs in the form of RF input pins 90, 92. The antennas 50, 60 coupled to the IC chips 49, 62 are configured to receive RF communication signals from the RFID reader 80 via the RF input pins 90, 92. Note that the RF input pins 90, 92 can also support any type of antenna, including dipole antenna, monopole antenna, or any other type of antenna. An antenna coupled to the RF input pins 90, 92 may be configured to operate at any frequency desired, including 2.4 GHz and 900 MHz, as examples.

As further illustrated in FIG. 10, the RF-enabled IC chips 49, 62 can be designed to be coupled in a daisy-chain fashion. Ground is coupled together for each IC chip 49, 62 when a connection is established by coupling ground pins 94, 96 of the IC chips 49, 62 together via a ground line 98. One or more capacitors 100 may be coupled between PWR and GND to provide energy storage of power received from RF communication signals to allow the IC chip 49 to operate when not being energized by an RF communication signal. Also as illustrated in FIG. 10, the IC chips 49, 62 are configured to communicate with each other over a serial bus communication line 102. Each IC chip 49, 62 contains at least one communication pin 104, 106. Each communication pin 104, 106 allows serial communications to and from the IC chips 49, 62. Additional IC chips, RF-enabled or not, could be connected together in a daisy-chain fashion and communicatively coupled to each other if a second communication pin is provided in the IC chip.

Also in this embodiment, during a condition change or activation of an IC chip, the RFID reader 80 may also communicate to the transponder 48, 58 to cause a light source 114, such as a light emitting diode (LED) or other light source coupled to an LED pin 116, to light up to indicate to the technician which second connector 32 to connect to the first connector 30. Other examples of light sources that may comprise the light source include a liquid crystal display (LCD) and an electroluminescent display. The light source 114 may be powered by energy from the interrogation signal 84 transmitted by the RFID reader 80, as illustrated in FIG. 9. A capacitor bank 118 may also be provided in the transponder 58 to be charged during interrogation by the RFID reader 80 and to provide reserve power to the light source 114 when not being interrogated by the RFID reader 80 or when energy from the RFID reader 80 is sporadic or otherwise not strong enough to power the second connector 32. Note that the light source 114 and the components described in this regard with respect to the second connector 32 could also be provided for the transponder 48 provided in the first connector 30.

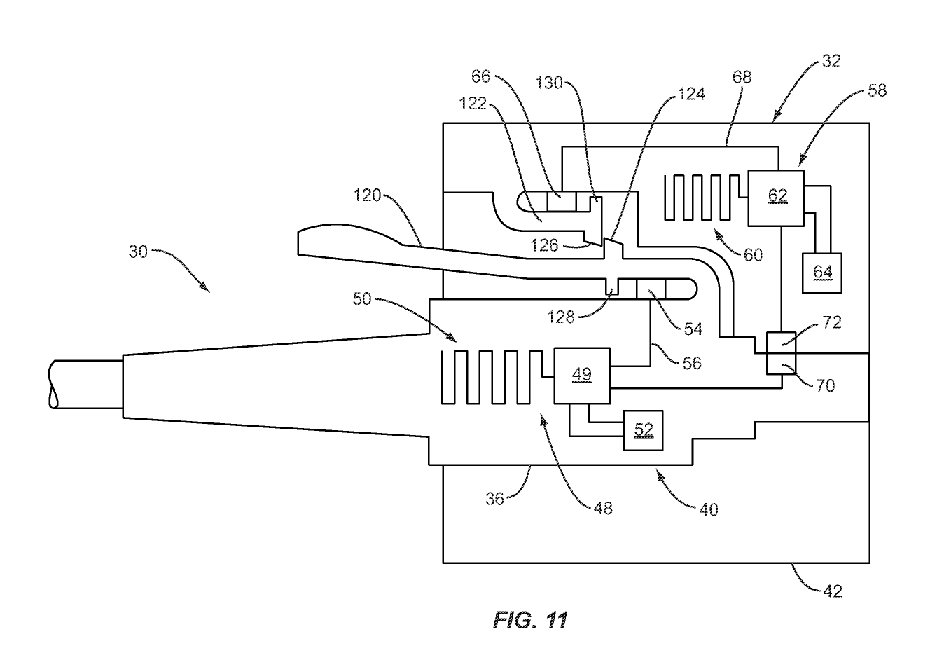

The first and second connectors 30, 32 illustrated in FIGS. 2-5 and discussed above only require one of the RF-enabled latches 34, 46 to be actuated to affect the latches 34, 46 to allow the demating of the first connector 30 from the second connector 32. Alternative embodiments can be provided. For example, it may be desired to require that both latches 34, 46 be actuated to affect the latches 34, 46 to allow the demating of the first connector 30 from the second connector 32. In this regard, FIGS. 11-14 illustrate a variation of the first and second connectors 30, 32 of FIGS. 2-5, wherein alternative RF-enabled latches are disposed therein that must both be actuated to allow a protrusion disposed in one latch to clear a protrusion disposed in the other latch to allow the demating of the first connector 30 from the second connector 32.

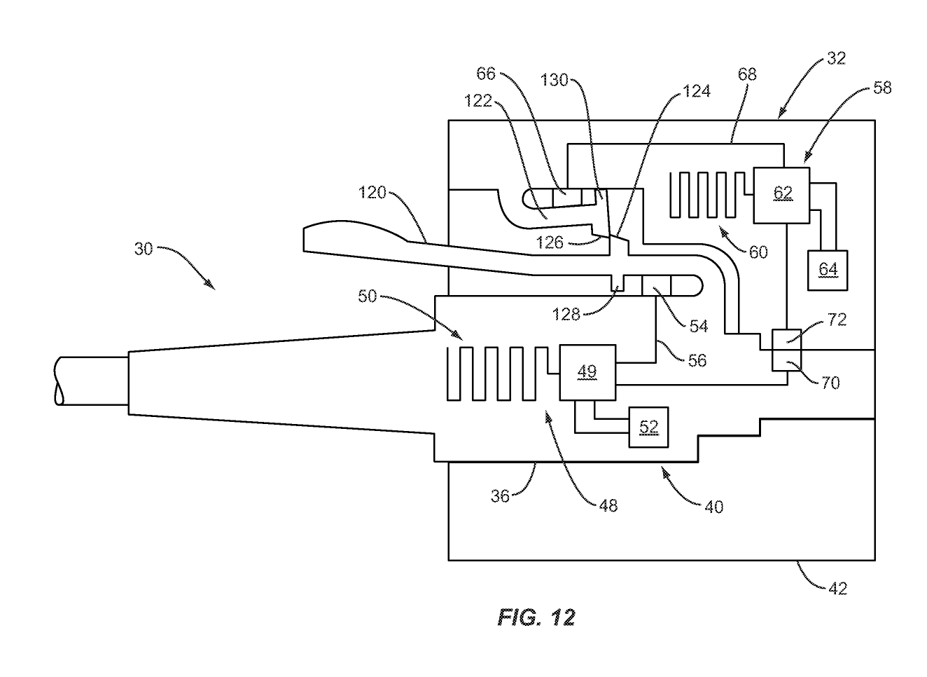

In this regard, FIG. 11 is a side view of a cross-section of the first connector 30 mated to the second connector 32, wherein the first and second connectors 30, 32 include alternative RF-enabled latches 120, 122, respectively. As will be described in more detail below and illustrated in FIGS. 12-14, both latches 120, 122 must be actuated in this embodiment to affect the latches 120, 122 to allow the demating of the first connector 30 from the second connector 32. The previous discussions regarding FIGS. 2-5 for common element numbers provided in FIGS. 11-14 are applicable for the embodiment illustrated in FIGS. 11-14 and thus will not be repeated. Further, the first connector 30 and second connector 32 in FIGS. 11-14 having the alternative latches 120, 122 disposed therein may be provided in the systems illustrated in FIGS. 9 and 10 and described above.

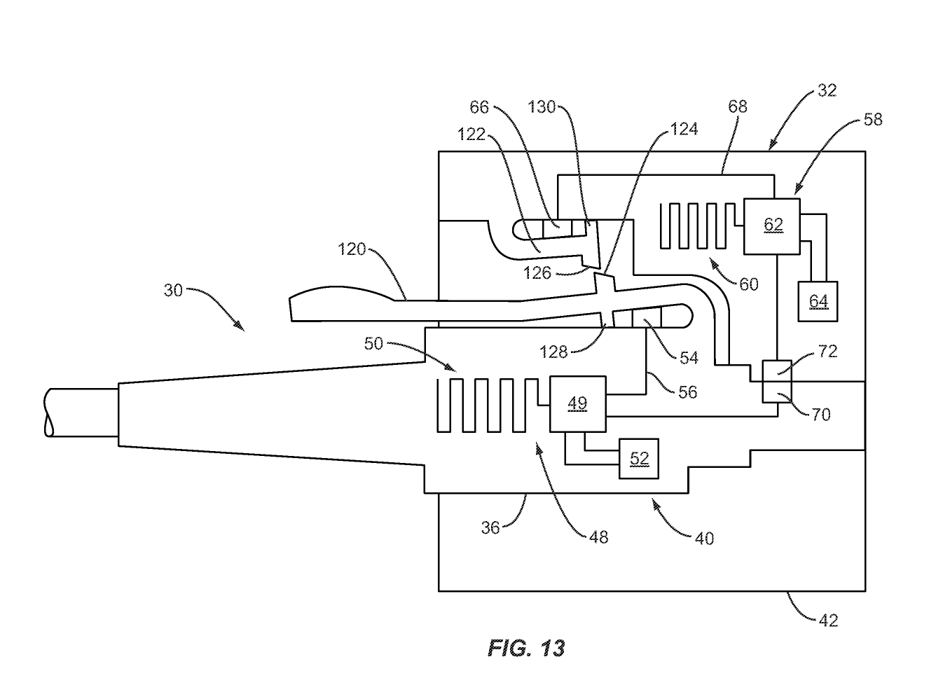

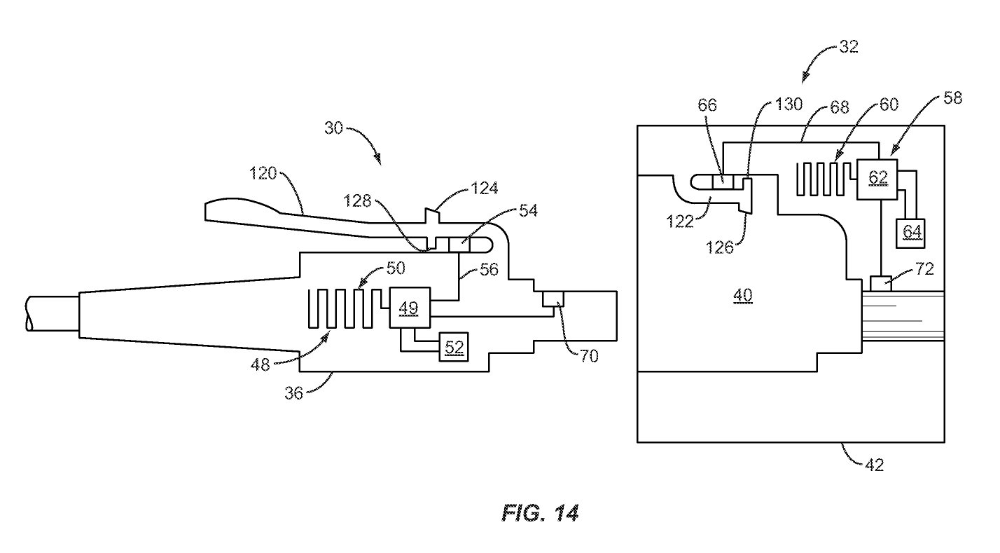

With continuing reference to FIG. 11, the latch 120 is provided that contains a protrusion 124 disposed therein. The protrusion 124 is designed to interfere with a protrusion 126 disposed in the latch 122 when not actuated so that the first connector 30 cannot be demated from the second connector 32. The latches 120, 122 are still actuated by actuators 54, 66 as previously described. However in these embodiments, the latches 120, 122 also contain actuation limiters 128, 130, respectively, as illustrated in FIG. 8. Thus, if latch 122 is actuated, as illustrated in FIG. 12, or when latch 120 is actuated, as illustrated in FIG. 13, the actuation limiters 128, 130 limit the distance by which the protrusions 124, 126 move. Thus, in this embodiment, as illustrated in FIG. 12, when the latch 122 is actuated by the transponder 58 in the second connector 32, the protrusion 126 disposed therein is still not clear from the protrusion 124 in the latch 120. Thus, the first connector 30 is prevented from demating from the second connector 32. Only when both latches 120, 122 are actuated by their respective transponders 48, 58, as illustrated in FIG. 13, are the protrusions 124, 126 cleared from each other to affect the latches 120, 122 to allow the demating of the first connector 30 from the second connector 32, as illustrated in FIG. 14.

It may be desired to provide a mechanism to automatically ensure that the first connector 30 is demated from the second connector 32 when one or both of the latching mechanisms 54, 66 are actuated to actuate the latches. However, actuation of the latches may not demate the first connector 30 from the second connector 32 such that their respective interfaces 70, 72 are not disconnected unless further action is taken to physically pull the first connector from the internal chamber 40 of the second connector 32. This would require technician interaction to ensure demating. However, it may be desired to ensure demating without requiring a technician to physically pull the first connector 30 from the internal chamber 40 of the second connector 32. For example, communication to a transponder 48, 58 to actuate a latching mechanism 54, 66 to affect the latching mechanism 54, 66 to allow demating of the first connector 30 from the second connector 32 may be initiated from a remote system when a technician is not present at the actual first and second connectors 30, 32. It may be desired to demate the first and second connectors 30, 32 quickly, on demand, for any number of reasons.

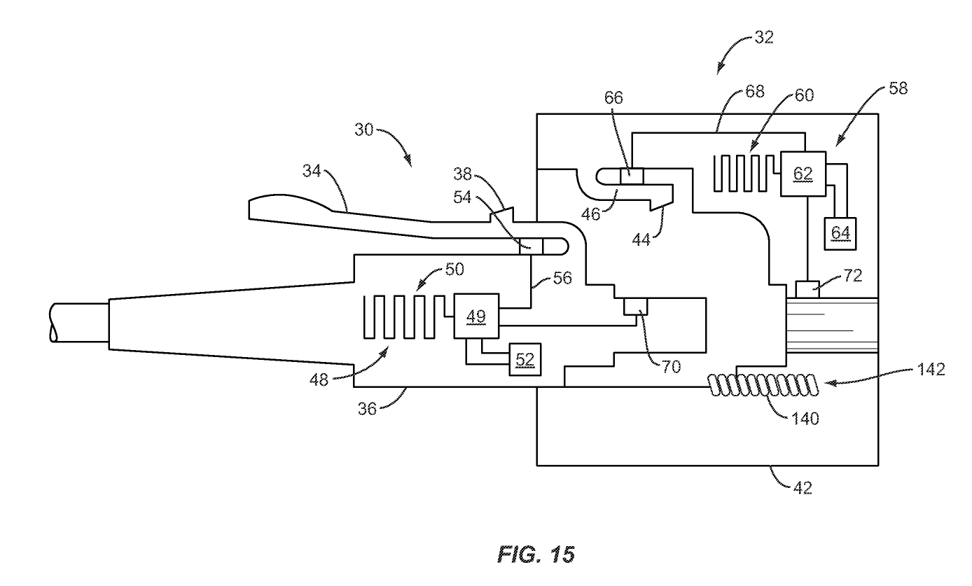

In this regard, FIG. 15 illustrates the first and second connectors 30, 32 with their RF-enabled latches 34, 46 of FIGS. 2-5, but with the addition of a spring 140. The spring 140 may be a coil spring for example. The spring 140 is disposed in a chamber 142 disposed in the body 42 of the second connector 32 in this embodiment. The spring 140 is configured to be in an uncompressed state when the first connector 30 is not inserted into the internal chamber 40 of the second connector 32. As the first connector 30 is inserted into the second connector 32, the body 36 of the first connector 30 starts to compress the spring 140 to store energy. When the protrusion 38 disposed in the latch 34 passes across the protrusion 44 in the latch 46 such that the first connector 30 is locked into the second connector 32, the interference between the protrusions 38, 44 keeps the spring 140 compressed due to the force laced on the spring 140 by the body 36 of the first connector 30. When one or both of the latching mechanisms 54, 66 are actuated to clear interference between the protrusions 38, 44, the energy stored in the spring 140 pushes against the body 36 of the first connector 30 to push the first connector 30 away from the second connector 32 to disconnect the connection between the interfaces 70, 72 to ensure automatic demating without requiring a technician to physically pull the first connector 30 from the second connector 32 to disconnect the interfaces 70, 72.

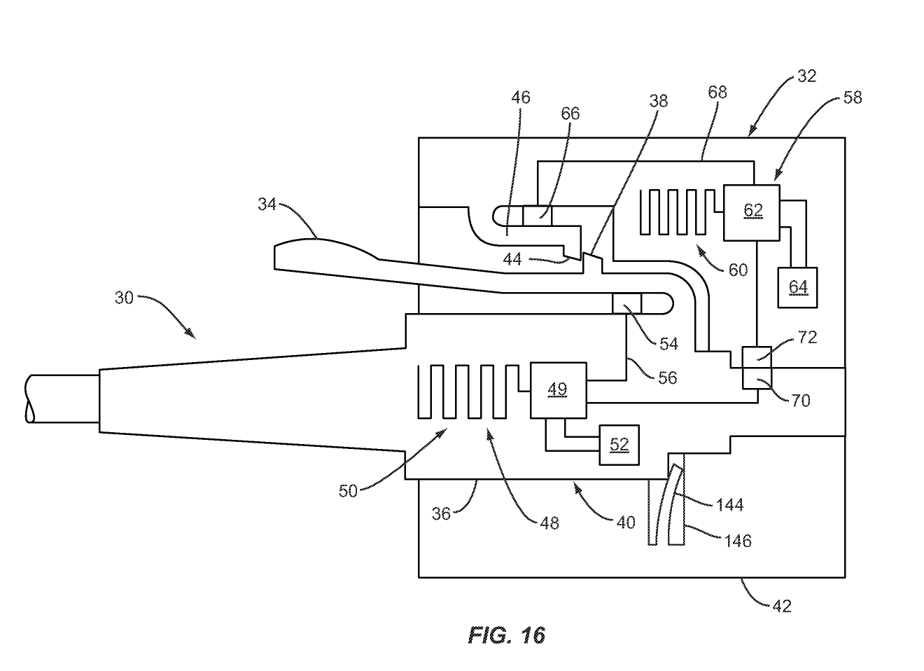

Other spring types other than a coil spring are possible. For example, FIG. 16 illustrates a leaf spring 144 disposed in a chamber 146 in the body 42 of the second connector 32 that contains the latches 34, 46 in FIGS. 2-5 as an example. The leaf spring 144 is configured to be in an unbent state when the first connector 30 is not inserted into the internal chamber 40 of the second connector 32. As the first connector 30 is inserted into the second connector 32, the body 36 of the first connector 30 bends the leaf spring 144, as illustrated in FIG. 16, to store energy. When the protrusion 38 disposed in the latch 34 passes across the protrusion 44 in the latch 46 such that the first connector 30 is locked into the second connector 32, the interference between the protrusions 38, 44 keeps the leaf spring 144 bent due to the force placed on the leaf spring 144 by the body 36 of the first connector 30. When one or both of the latching mechanisms 54, 66 are actuated to clear interference between the protrusions 38, 44, the energy stored in the leaf spring 144 pushes against the body 36 of the first connector 30 to push the first connector 30 away from the second connector 32 to disconnect the connection between the interfaces 70, 72 to ensure automatic demating without requiring a technician to physically pull the first connector 30 from the second connector 32 to disconnect the interfaces 70, 72.

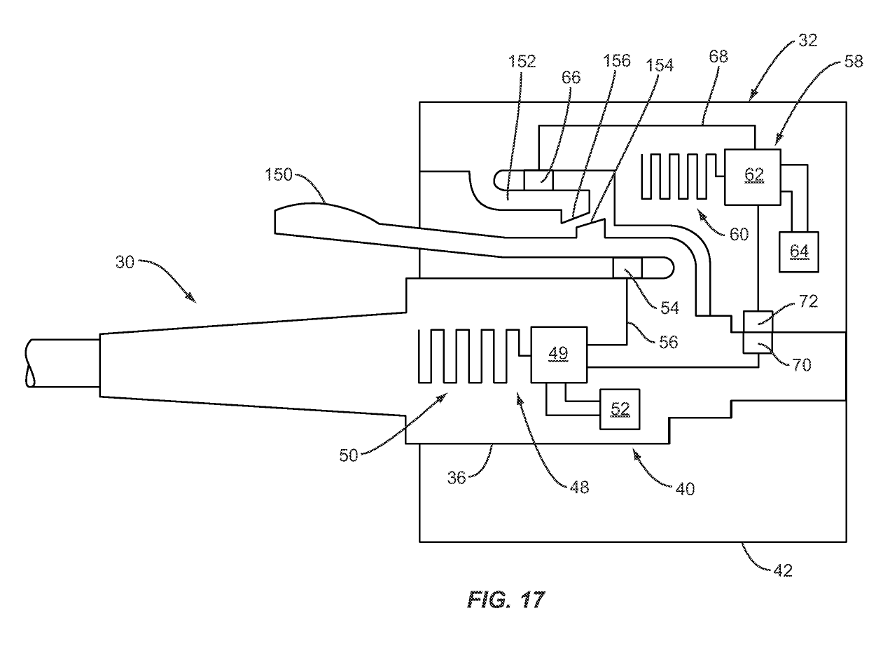

The embodiments described above contain RF-enabled latches that are biased to allow the first connector 30 to be mated with the second connector 32 without requiring actuation of the latches by transponders. Thus, as previously described above, a technician could insert the first connector 30 into the internal chamber 40 of the second connector 32 wherein the pushing force and interference between protrusions disposed in the latches causes the protrusions to clear from each other to allow mating without actuation of the latching mechanisms 54, 66. However, it may be desired to provide the opposite—that is, to require actuation of one or both of the latching mechanisms 54, 66 to mate the first connector 30 to the second connector 32, but not require actuation of one or both of the latching mechanisms 54, 66 to demate the first connector 30 from the second connector 32. In this regard, FIG. 17 illustrates an embodiment of the first and second connectors 30, 32 that include alternative latches 150, 152 that are biased to allow the mating, but not demating, of the first connector 30 to the second connector 32 without requiring actuation the latching mechanisms 54, 66 to actuate the latches 150, 152.

In this regard, FIG. 17 is a side view of a cross-section of the first connector 30 mated to the second connector 32, wherein the first and second connectors 30, 32 include alternative RF-enabled latches 150, 152, respectively. As described in more detail below, the latches 150, 152 are biased such that actuation of the latching mechanisms 54, 66 is not required for the first connector 30 to be demated from the second connector 32. However, actuation of at least one actuator 54, 66 is required to affect the latches 150, 152 to allow mating of the first connector 30 to the second connector 32. The previous discussions regarding FIGS. 2-5 for common element numbers provided in FIG. 17 is applicable for the embodiment illustrated in FIG. 17 and thus will not be repeated. Further, the first connector 30 and second connector 32 in FIG. 17 having the alternative latches 150, 152 disposed therein may be provided in the systems illustrated in FIGS. 6 and 10 and described above.

With continuing reference to FIG. 17, the latch 150 is provided that contains a protrusion 154 disposed therein. The protrusion 154 is designed to interfere with a protrusion 156 disposed in the latch 152 when not actuated so that the first connector 30 cannot be mated with the second connector 32. The latches 150, 152 are still actuated by actuators 54, 66 as previously described. However, in these embodiments, the protrusions 154, 156 disposed in the latches 150, 152 are biased with angles in directions reversed from the angles disposed in the protrusions in FIGS. 2-14 such that the protrusions 154, 156 will interfere with each other if at least one of the latching mechanisms 54, 66 is not actuated to prevent the full insertion of the first connector 30 into the internal chamber 40 of the second connector 32 to allow mating. Thus, in this embodiment, as illustrated in FIG. 17, when either latch 150 or 152 is actuated by its respective transponders 48, 58, the first connector 30 can only be mated to the second connector 32 when the protrusions 154, 156 do not interfere.

Note that although not illustrated in FIG. 17, the latches 150, 152 could be configured such that both latches 150, 152 must be actuated by their respective actuators 54, 66 to affect the latches 150, 152 to allow the first connector 30 to be mated to the second connector 32. For example, actuation limiters like the actuation limiters 128, 130 provided in the latches 120, 122 in the first and second connectors 30, 32 in FIGS. 8-14 could be disposed in the latches 150, 152 in the first and second connectors 30, 32 in FIG. 17. Thus, in this scenario, only when both latches 150, 152 are actuated by their respective transponders 48, 58 would the protrusions 154, 156 be cleared from each other to allow the mating of the first connector 30 to the second connector 32, as illustrated in FIG. 17.

The embodiments described to this point have include a single latch 34 disposed in the first connector 30 that is configured to be actuated either manually or by the latching mechanism 54 via control by the transponder 48. Thus, only either manual actuation or actuation of the latching mechanism 54 via the transponder 48 was required to actuate the latch 34. However, more than one latch can be disposed in either the first connector 30 and/or the second connector 32 if desired. For example, it may be desired to provide one latch that must be manually actuated and another, separate latch that must be actuated via a latching mechanism controlled by the transponder 48 to affect the latch 34 to allow mating and/or demating of the first connector 30 to and/or from the second connector 32.

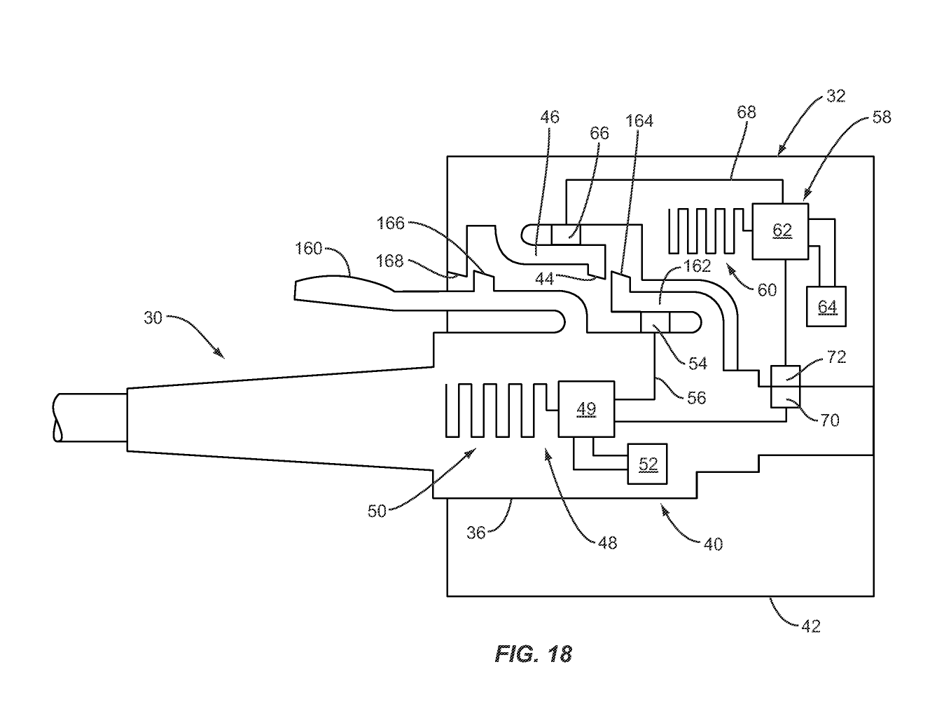

In this regard, FIG. 18 illustrates the first and second connectors 30, 32 of FIGS. 2-5, but employing an alternative latch system in the first connector 30. The latch system employed in the second connector 32 is the same latch 46 as employed in the second connector 32 in FIGS. 2-5. The latch system employed in the first connector 30 consists of two separate latches. One latch 160 disposed in the body 36 of the first connector 30 is a manually-actuated latch similar to the latch 34 in FIGS. 2-5. However, the latch 160 can only be actuated via manual actuation, such as by a technician. A latch 162 is also disposed in the body 36 of the first connector 30, but is provided as a separate latch from the latch 160. The latch 162 can only be actuated by the latching mechanism 54 under control of the transponder 48. The latch 162 contains a protrusion 164 similar to the protrusion 38 disposed in the latch 34 of the first connector 30 illustrated in FIGS. 2-5 that is configured to interfere with the protrusion 44 in the latch 46 to prevent demating of the first connector 30 from the second connector 32 when either latch 46 or latch 162 is not actuated by actuators 54, 66, respectively.

However, in addition to actuation of either or both latches 46, 162 to affect the latches 46, 162 to allow demating of the first connector 30 from the second connector 32, the manually-actuated latch 160 may also be actuated. A protrusion 166 is disposed in the manually-actuated latch 160 that is configured to interfere with a protrusion 168 disposed inside the internal chamber 40 in the body 42 of the second connector 32 when the manually-actuated latch 160 is not actuated. When actuated, the protrusion 166 disposed in the manually-actuated latch 160 is configured to clear the protrusion 168 disposed in the body 42 of the second connector 32 so that the first connector 30 can be demated from the second connector 32. In this regard, the protrusions 166, 168 are biased like the biasing provided in the protrusions 44, 164 in the latches 46, 162 so that actuation is necessary to affect the latches 46, 162 to allow demating of the first connector 30 from the second connector 32. However, note that the biasing of the protrusions 44, 164 in the latches 46, 162 and the protrusions 166, 168 could be biased, including like that provided in FIG. 17, to only allow mating when the latches 46 and/or 162 and manually-actuated latch 160 are actuated.

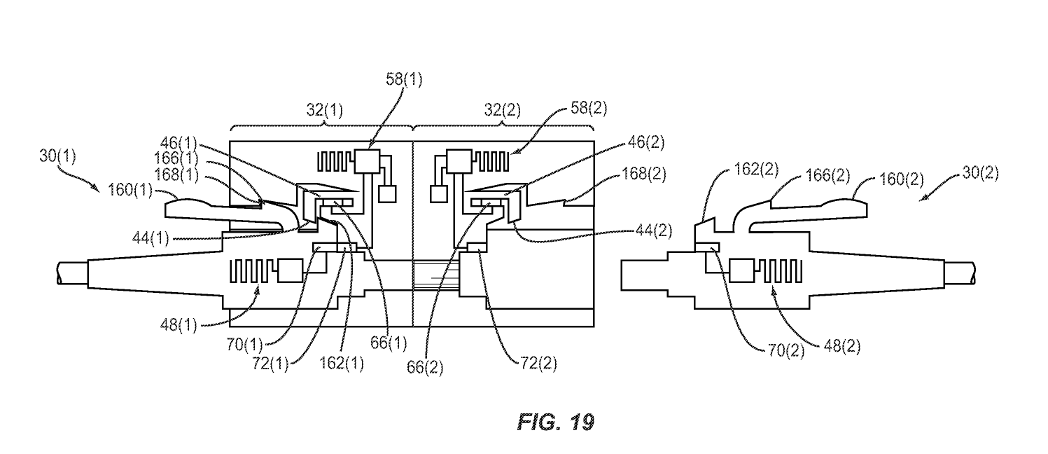

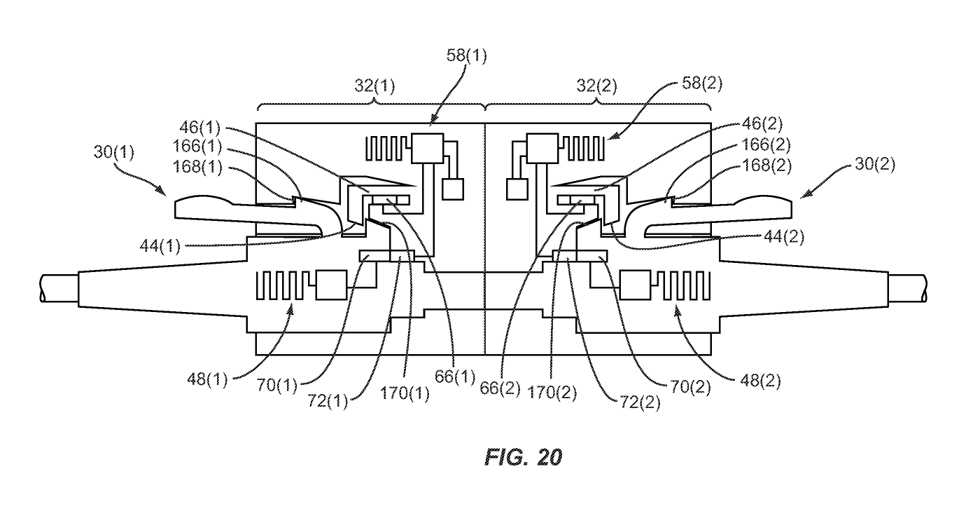

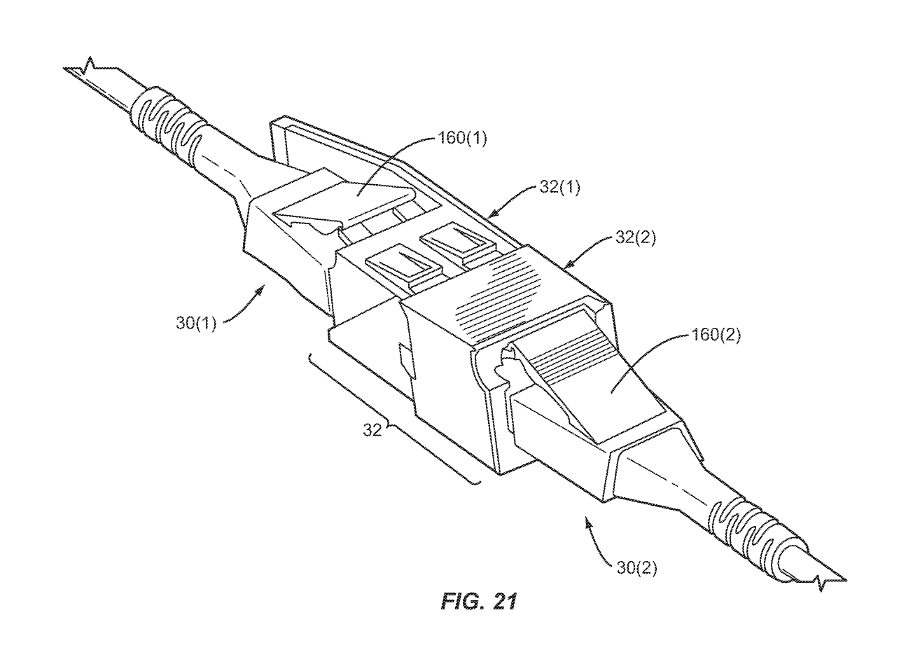

The embodiments disclosed herein may also be employed to connect first connectors 30 together, wherein the second connector 32 is provide as an adapter component to facilitate the connection of two first connectors 30 together. In this regard, FIGS. 19 and 20 illustrate a first connector 30(1) like the first connector 30 previously described, connected to another first connector 30(2), also like first connector 30 previously described. A second connector 32 is provided that includes two second connectors 32(1), 32(2) that are configured to each receive the first connectors 30(1), 30(2), respectively. In FIG. 19, the first connector 30(1) is mated to the second connector 32(1), and the first connector 30(2) is not mated to the second connector 32(2). Each of the first connectors 30(1), 30(2) and second connectors 32(1), 32(2) can contain transponders 48(1), 48(2) and 58(1), 58(2), respectively, as previously described. For example, if the first connectors 30(1), 30(2) were duplex LC fiber optic connectors and the second connectors 32(1), 32(2) were duplex LC fiber optic adapters, FIG. 21 illustrates what connection of the first connectors 30(1), 30(2) to the second connectors 32(1), 32(2) may appear. The aspects described in the embodiments above may be employed in the connectors illustrated in FIGS. 19 and 20 and thus will not be repeated. In the embodiments illustrated in FIGS. 19 and 20, the first connectors 30(1), 30(2) include the latches disposed in the first connector 30 illustrated in FIG. 18 to prevent demating of the first connectors 30(1), 30(2) from the second connectors 32(1), 32(2), as previously described, and thus a discussion of same will not be repeated. The second connectors 32(1), 32(2) also include the latches disposed in the second connector 32 illustrated in FIG. 18 and thus a discussion of same will not be repeated as well.

The disclosed technologies can be configured in different ways, resulting in different functionalities. In addition to the examples provided above, the components may be connector components. The connector components may be provide as a plug, a socket or adapter, a housing, a cabinet, an equipment rack, a component or patch panel, a separate object, or other components (or portions thereof). Both the first connector 30 and second connector 32 each do not have to include RF-enabled latches. The components disclosed herein can be any type of connectors and do not have to be connectors for communications. The connections established by the connectors disclosed herein may be for other applications, including power connections, fluidic connections (hoses, tubing, etc.), pneumatic connections, mechanical force transfer couplings (linear or rotational), etc. The connectors disclosed herein could be temporarily installed in networks and interconnection systems and articles of manufacture such as fire hoses, sports or performance events, or power and communications networks associated with military deployment.

It should also be understood that elements of the embodiments below may be mixed in different ways to achieve still further embodiments and functionality within the scope of the embodiments herein.

Any functionalities disclosed in any embodiments may be incorporated or provided in any other embodiments with suitable circuitry and/or devices. Although the illustrated embodiments are directed to components, wherein RF-enabled versions of the components, including ICs and IC chips, employ passive transponders, further embodiments include one or more semi-passive or active transponders depending upon the particular functionality of the transponder system desired.

The embodiments disclosed herein are applicable to any type of component. Examples include fiber optic connectors and adapters or copper connectors and adapters and other fiber optic and/or copper components. Embodiments disclosed herein can be used in non-telecommunications equipment, particularly regarding components that interconnect and/or are exposed to various conditions for which it is desirable to know the location, connectivity, and/or conditions of the components. The terms “plug” and “socket” are generally used herein to define portions of components that are adapted for connecting to one another. Examples include, but are not limited to, a connector that is received by an adapter and an adapter that receives another connector. The components herein are not necessarily limited to standard plugs and sockets, but can also include other applications such as, for example, fluid couplings, containers with lids or other sealing devices, windows and sills, doors and doorframes, and any other components that can be mated or latched.

Many modifications and other embodiments of the invention set forth herein will come to mind to one skilled in the art to which the invention pertains having the benefit of the teachings presented in the foregoing descriptions and the associated drawings.

Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

What is claimed is:

1. A component, comprising:
a body configured to be mated to a second component to establish a connection;
a latch disposed in the body and configured to either affect demating of the body from the second component or affect mating of the body to the second component when the latch is not actuated; and
a transponder disposed in the body and configured to receive an instruction to actuate the latch to either affect demating of the body from the second component or affect mating of the body to the second component.

2. The component of claim 1, wherein the transponder is configured to receive the instruction to actuate the latch to provide at least one of allowing demating of the body from the second component and preventing demating of the body from the second component.

3. The component of claim 1, wherein the transponder is configured to receive the instruction to actuate the latch to provide at least one of allowing mating of the body to the second component and preventing mating of the body to the second component.

4. The component of claim 1, wherein the instruction to actuate the latch is received from a radio frequency identification (RFID) reader.

5. The component of claim 1, wherein the transponder is further configured to establish a communication connection to a second transponder disposed in the second component when the body is mated to the second component.

6. The component of claim 5, wherein the instruction to actuate the latch is received from the second transponder.

7. The component of claim 5, wherein the second transponder is comprised of a second RFID transponder, and wherein the transponder is further configured to receive identification information of the second RFID transponder over the communication connection.

8. The component of claim 7, wherein the transponder is configured to receive the instruction to actuate the latch to affect demating of the body from the second component or affect mating of the body to the second component based on the identification information of the second RFID transponder.

9. The component of claim 7, wherein the transponder is configured to receive the instruction to actuate the latch to affect demating of the body from the second component or affect mating of the body to the second component based on lack of identification information.

10. The component of claim 5, wherein the demating of the body from the second component disconnects the communication connection between the transponder and the second transponder.

11. The component of claim 5, wherein the communication connection is comprised of a wired communication connection.

12. The component of claim 1, wherein actuation of the latch is comprised from the group consisting of actuation of a bladder, actuation of a motor, a solenoid, a thermal actuator, a microelectromechanical system (MEMs) device, or a motion-inducing device.

13. The component of claim 1, further comprising a spring disposed in the body configured to actively disconnect the body from the second component when the latch is actuated.

14. The connector of claim 1, wherein the component is a connector component comprised from the group consisting of a connector, an adapter, a fiber optic connector, a fiber optic adapter, an electrical connector, an electrical adapter, a plug, a socket, or any other connector of a mating pair or set.

15. The component of claim 1, wherein the latch is biased to not affect demating of the body from the second component without actuation of the latch.

16. The component of claim 1, wherein the latch is configured to be actuated manually to either affect demating of the body from the second component or affect mating of the body to the second component.

17. The component of claim 1, further comprising a second latch disposed in the body, wherein the latch and the second latch must be actuated to either affect demating of the body from the second component or affect mating of the body to the second component.

18. The component of claim 17, wherein the second latch is a manually-actuated latch.

19. A method to affect demating or mating of a component, comprising:
mating a body to a second component to establish a connection; and
receiving an instruction at a transponder disposed in the body to actuate a latch disposed in the body to either affect demating of the body from the second component or affect mating of the body to the second component.

20. The method of claim 19, wherein receiving the instruction comprises receiving the instruction at the transponder disposed in the body to actuate the latch disposed in the body to provide at least one of allowing demating of the body from the second component and preventing demating of the body from the second component.

21. The method of claim 19, wherein receiving the instruction comprises receiving the instruction at the transponder disposed in the body to actuate the latch disposed in the body to provide at least one of allowing mating of the body to the second component and preventing mating of the body to the second component.

22. The method of claim 19, wherein receiving the instruction to actuate the latch is received from a radio frequency identification (RFID) reader or the transponder.

23. The method of claim 19, further comprising the transponder establishing a communication connection to a second transponder disposed in the second component when the body is mated to the second component.

24. The method of claim 23, wherein the second transponder is comprised of a second RFID transponder and further comprising the transponder receiving identification information of the second RFID transponder over the communication connection.

25. The method of claim 24, further comprising the transponder receiving the instruction to actuate the latch to affect demating of the body from the second component or affect mating of the body to the second component based on the identification information of the second RFID transponder.

26. The method of claim 24, further comprising the transponder not receiving the instruction to actuate the latch to affect demating of the body from the second component or affect mating of the body to the second component based on lack of identification information.

27. The method of claim 24, further comprising demating of the body from the second component to disconnect the communication connection between the transponder and the second RFID transponder.

28. The method of claim 19, further comprising manually actuating the latch to either affect demating of the body from the second component or affect mating of the body to the second component.

29. The method of claim 19, further comprising a second latch disposed in the body, wherein the latch and the second latch must be actuated to either affect demating of the body from the second component or affect mating of the body to the second component, and further comprising actuating the latch and the second latch to either affect demating of the body from the second component or affect mating of the body to the second component.

30. A component system, comprising:
a first component, comprising:
a first body; and
a first transponder disposed in the first body; and
a second component, comprising:
a second body configured to be mated to the first body to establish a connection with the first component;
a second latch disposed in the second body and configured to either affect demating of the first body from the second body or affect mating of the first body to the second body when the second latch is not actuated; and
a second transponder disposed in the second body and configured to receive an instruction to actuate the second latch to either affect demating of the second body from the second component or affect mating of the second body to the second component.

31. The component system of claim 30, wherein the second latch is configured to provide at least one of allowing demating of the first body from the second body and preventing demating of the first body from the second body when the second latch is not actuated.

32. The component system of claim 30, wherein the second latch is configured to provide at least one of allowing mating of the first body to the second body and preventing mating of the first body to the second body when the second latch is not actuated.

33. The component system of claim 30, wherein the second transponder is comprised of a second radio frequency identification (RFID) transponder further configured to send identification information of the second RFID transponder to the first transponder through a communication connection.

34. The component system of claim 33, wherein the second RFID transponder is further configured to receive the instruction to actuate the second latch to either affect demating of the first body from the second body or affect mating of the first body to the second body based on the identification information of the second RFID transponder.

35. The component system of claim 33, wherein the second transponder is further configured to not actuate the second latch to affect demating of the first body from the second body or affect mating of the first body to the second body based on lack of identification information.

36. The component system of claim 30, wherein the second latch is biased to not affect demating of the first body from the second body without actuation of the second latch.

37. The component system of claim 30, wherein the second latch is biased to not affect mating of the first body to the second body without actuation of the second latch.

38. The component system of claim 30, wherein the first transponder further comprises a first latch disposed in the first body and configured to either affect demating of the first body from the second body or affect mating of the first body to the second body when the first latch is not actuated.

39. The component system of claim 38, wherein the first latch is configured to allow at least one of demating of the first body from the second body and mating of the first body to the second body when the first latch is not actuated.

40. The component system of claim 38, wherein the first latch is configured to prevent at least one of demating of the first body from the second body and mating of the first body to the second body when the first latch is not actuated.

41. The component system of claim 38, wherein the second transponder is comprised of a second RFID transponder, and wherein the first transponder is configured to:
communicate identification information of the second RFID transponder to a reader; and
receive an instruction from the reader to actuate the first latch to either affect demating of the first body from the second body or affect mating of the first body to the second body based on the identification information of the second RFID transponder; and
wherein only one of the first latch and the second latch must be actuated to either affect demating of the first body from the second body or affect mating of the first body to the second body.

42. The component system of claim 38, wherein the second transponder is comprised of a second RFID transponder, and wherein the first transponder is configured to:
communicate identification information of the second RFID transponder to a reader; and
receive an instruction from the reader to actuate the first latch to either affect demating of the first body from the second body or affect mating of the first body to the second body based on the identification information of the second RFID transponder; and
wherein both the first latch and the second latch must be actuated to either affect demating of the first body from the second body or affect mating of the first body to the second body.

43. The component system of claim 30, further comprising a manually-actuated third latch disposed in the first body, wherein both the second latch and the third latch must be actuated to either affect demating of the first body from the second body or affect mating of the first body to the second body.

44. The component system of claim 38, further comprising a third latch disposed in the first body, wherein the first latch and the third latch must be actuated to either affect demating of the first body from the second body or affect mating of the first body to the second body.

45. The component system of claim 30, wherein the second transponder is configured to receive the instruction to actuate the second latch to either affect demating of the first body from the second body or affect mating of the first body to the second body.
